(19) United States
(12) Patent Application Publication
(10) Pub. No.: US 2017/0085007 A1
(43) Pub. Date: Mar. 23, 2017

(54) MULTI-ANTENNA STRUCTURE WITH HIGH-ISOLATION EFFECT

(71) Applicant: ARCADYAN TECHNOLOGY CORPORATION, Hsinchu City (TW)

(72) Inventors: MIN-CHI WU, Hsinchu County (TW); Kuo-Chang Lo, Miaoli County (TW)

(21) Appl. No.: 15/095,623

(22) Filed: Apr. 11, 2016

(30) Foreign Application Priority Data
Sep. 22, 2015 (TW) 104131299

(51) Int. Cl. H01Q 21/24; H01Q 9/04; H01Q 1/52

(52) U.S. Cl. CPC H01Q 21/24; H01Q 1/523; H01Q 9/0421; H01Q 1/242

(57) ABSTRACT

A multi-antenna structure with high-isolation effect includes a substrate and a plurality of antennas. The substrate, formed as a symmetric polygonal metal board, has a plurality of grooves and a plurality of board edges. The antennas vertically installed on the board edges and having a conjunction portion close to the substrate includes a support member and a feed-in member. A radiation member of the antenna connected perpendicular to the support member and the feed-in member has a free radiation end. If virtual extension lines from the radiation ends of any two neighboring antennas are crossed, at least two grooves are constructed in between thereof. If virtual extension lines of the radiation ends of any two neighboring antennas don't cross, at least one groove is constructed between the two neighboring antennas. The groove is applied to avoid signal interference between any two neighboring antennas.

### CROSS REFERENCE TO RELATED APPLICATION

This application claims the benefit of Taiwan Patent Application Serial No. 104131299, filed Sep. 22, 2015, the subject matter of which is incorporated herein by reference.

### BACKGROUND OF INVENTION

1. Field of the Invention

The invention relates to a multi-antenna structure, and more particularly to the multi-antenna structure with high-isolation effect that can improve and relevantly adjust the isolation of an MIMO (Multi-input multi-output) antenna of a wireless communication device, according to specific requirements.

2. Description of the Prior Art

In the blooming age of technology development, various small-size antennas have been introduced to the market to meet different miniaturized requirements for portable electronic devices (such as mobile phones, notebook computers and so on) and wireless communication devices (such as USB Dongles, wireless LAN cards, APs and so on). For instance, the planar inverse-F antenna (PIFA) or the monopole antenna, both of which is featured in light-structuring and powerful communication capability, can be easier facilitated into an inner wall of the portable electronic device. These antennas are also widely applied to various wireless communication units of portable electronic devices, notebook computers or wireless communication apparatuses. In the art, a conductive core and a woven conductive shield of a coaxial cable are usually soldered to a feed-in port and a signal ground port of a PIFA, respectively, so that the communicative signals can be transmitted through the PIFA. It is understood that the PIFA has already been widely used in various wireless communication units of portable electronic devices, notebook computers or wireless communication apparatuses. However, as the technology progresses, demands in a higher throughput and a longer transmission range for the MIMO antenna do always exist.

Currently, since the MIMO antenna is usually bothered by installation directionality and signal interference, a poor yield thereof is always a problem in production. Definitely, any improvement thereabout will be welcome to the art.

### SUMMARY OF THE INVENTION

Accordingly, it is the primary object of the present invention to provide a multi-antenna structure with high-isolation effect that can improve and relevantly adjust the isolation of an MIMO (Multi-input multi-output) antenna of a wireless communication device, according to specific requirements. The embodiments raised in this disclosure are applicable to operational frequency bandwidths at 802.11a (5150˜5850 MHz), 802.11b (2400˜2500 MHz), and 802.11g (2400˜2500 MHz). In addition, according to the present invention, the bandwidth can be slightly adjusted, particularly wider, to meet other requirements of antennas for wireless communication apparatuses.

In the present invention, the multi-antenna structure with high-isolation effect comprises:

a substrate, formed as a symmetric polygonal metal board having at least five sides, having a plurality of grooves and a plurality of board edges; and

a plurality of antennas, each of the antennas being constructed vertically to the respective board side, each of the board edges being allowed only to mount at most one said antenna, a conjunction portion of one said antenna and the substrate including a support member and a feed-in member, a radiation member of the antenna being extended from the conjunction portion and also perpendicular to the support member and the feed-in member, an free extension end of the radiation member being defined as a radiation end

wherein, in the case that any two said neighboring antennas are crossed in a manner of virtual extension lines extended from the corresponding free radiation ends, at least two grooves are constructed on the substrate by being disposed between the two said neighboring antennas;

wherein, in the case that any two said neighboring antennas are not crossed in a manner of virtual extension lines from the corresponding free radiation ends, at least one groove is constructed on the substrate to separate the two neighboring antennas so as thereby to avoid possible signal interference between these two antennas.

Preferably, the antenna is an inverse-F antenna.

Preferably, the groove is extended by perpendicular to the respective board edge of the substrate.

Preferably, the symmetric polygonal metal board is shaped as one of a pentagon, a hexagon and an octagon.

Preferably, the pentagon has two antennas located symmetrically.

Preferably, the hexagon has three antennas located symmetrically.

Preferably, the octagon has four antennas located symmetrically.

Preferably, the feed-in member further has a middle cutoff portion for electrically coupling a coaxial cable, a conductive core and a woven conductive shield of the coaxial cable being electrically connected to opposing ends of the cutoff portion, respectively.

Preferably, a length of the groove is to vary impedance matching the antennas.

Preferably, the groove is extended inward from the respective board side of the substrate.

Preferably, the substrate and the plurality of antennas are integrated as a single piece.

All these objects are achieved by the multi-antenna structure with high-isolation effect described below.

### BRIEF DESCRIPTION OF THE DRAWINGS

The present invention will now be specified with reference to its preferred embodiment illustrated in the drawings, in which:

FIG. 1 is a schematic perspective view of a first embodiment of the multi-antenna structure with high-isolation effect in accordance with the present invention;

FIG. 2 is a schematic perspective view of a second embodiment of the multi-antenna structure with high-isolation effect in accordance with the present invention;

FIG. 3 shows schematically a distribution of radiation currents for a substrate without grooves in accordance with the present invention;

FIG. 4 shows schematically a distribution of radiation currents for a substrate with grooves in accordance with the present invention;

FIG. 5 is a schematic view of an embodiment of the substrate with grooves in accordance with the present invention, in which the substrate is shaped as a symmetric pentagon;

FIG. 6A is a schematic view of a first embodiment of the substrate with grooves in accordance with the present invention, in which the substrate is shaped as a symmetric hexagon;

FIG. 6B is a schematic view of a second embodiment of the substrate with grooves in accordance with the present invention, in which the substrate is shaped as a symmetric hexagon;

FIG. 7A is a schematic view of a first embodiment of the substrate with grooves in accordance with the present invention, in which the substrate is shaped as a symmetric octagon;

FIG. 7B is a schematic view of a second embodiment of the substrate with grooves in accordance with the present invention, in which the substrate is shaped as a symmetric octagon; and

FIG. 7C is a schematic view of a third embodiment of the substrate with grooves in accordance with the present invention, in which the substrate is shaped as a symmetric octagon.

### DESCRIPTION OF THE PREFERRED EMBODIMENT

The invention disclosed herein is directed to a multi-antenna structure with high-isolation effect. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

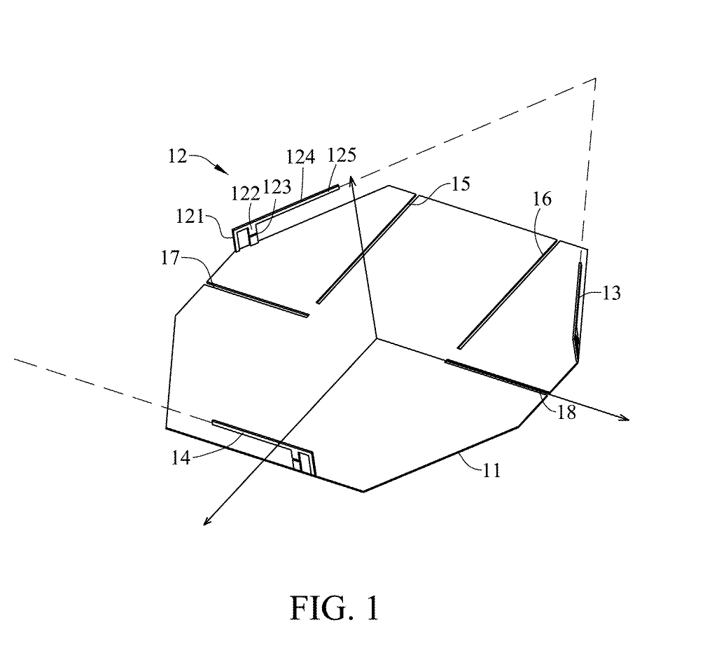

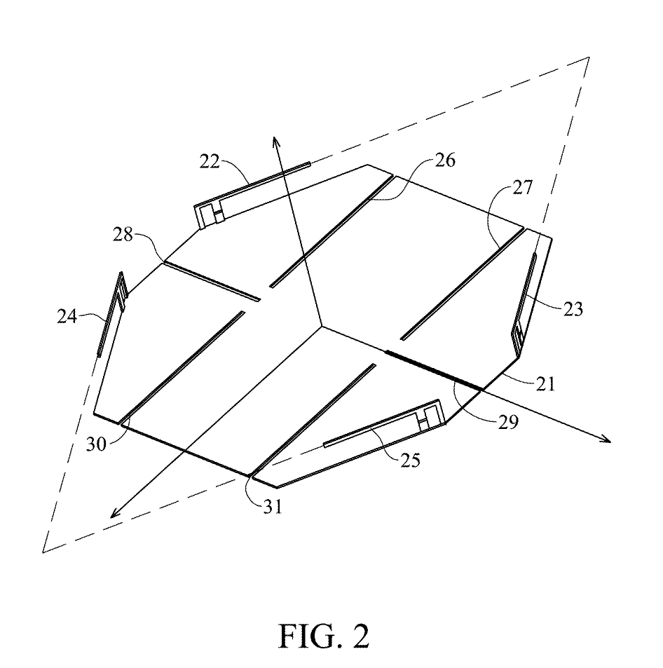

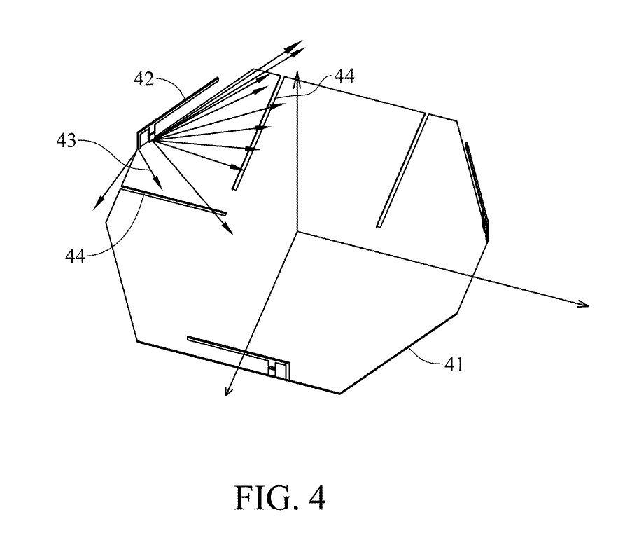

Referring now to FIG. 1 and FIG. 2, a first embodiment and a second embodiment of the multi-antenna structure with high-isolation effect in accordance with the present invention are schematically shown, respectively. Each of the multi-antenna structures with high-isolation effect includes a substrate 11, 21 formed as a symmetric polygonal metal board with five or more than five sides (an octagon in FIG. 1 and FIG. 2). the substrate 11, 12 has a plurality of grooves and a plurality of board edges, including a first grooves 15, 26, a second groove 16, 27, a third groove 17, 28, a fourth groove 18, 29, a fifth groove 30 (in the second embodiment only) and a sixth groove 31 (in the second embodiment only). Each of these grooves is extended, from the respective board side, into the substrate 11, 21 by perpendicular to the respective board edge of the polygon. The length of the groove in this present invention is to vary the impedance matching of the antenna. Each of the multi-antenna structures with high-isolation effect further includes a plurality of antennas, including a first antenna 12, 22, a second antenna 13, 23, a third antenna 14, 24 and a fourth antenna 25 (in the second embodiment only). Each of these antennas is constructed vertically to the respective board side of the substrate 11, 21. Each of the board edges is allowed only to mount at most one antenna. For example, typically, the conjunction portion of the antenna 12 and the substrate 11 includes a support member 121 and a feed-in member 122. A radiation member 124 of the antenna 12 is extended from the conjunction portion and also perpendicular to the support member 121 and the feed-in member 122. The free extension end of the radiation member 124 is defined as a radiation end 125. The feed-in member 122 of the antenna 12 further has a middle cutoff portion 123 for providing electrical coupling with a coaxial cable (not shown in the figure). The conductive core and the woven conductive shield of the coaxial cable are electrically connected to opposing ends of the cutoff portion 123, respectively. The antennas in FIG. 1 and FIG. 2 are formed as inverse-T antennas, and are individually integrated to the corresponding substrates 11, 21 as a single piece. Under such an arrangement, in the case that any two neighboring antennas have their own radiation ends 125 to be crossed in a virtual extension manner from the corresponding free radiation ends 125 (shown typically by the dashed lines in the figure), then at least two grooves (two in these two embodiments) are constructed on the substrate 11, 21 by being disposed between the two neighboring antennas. To the skill person in the art, he/she can easy to design a substrate that including three or more grooves between the two concerned antennas, after he/she learns the teaching of the present invention. In the case that any two neighboring antennas have their own radiation ends 125 not to be crossed in a virtual extension manner from the corresponding free radiation ends 125, then at least one groove shall be constructed on the substrate 11, 21 to separate these two neighboring antennas so as thereby to avoid possible signal interference between these two antennas. By having FIG. 1 as a typical example, the first antenna 12 and the second antenna 13 do intersect to each other in a manner of virtual extension lines from the respective radiation end 125, then the first groove 15 and the second groove 16 are in places on the substrate 11 between the two antennas 12, 13. On the other hand, since the first antenna 12 does not cross the third antenna 14, and the second antenna 13 does not cross the third antennas 14, both in a virtual extension manner, thus the third groove 17 only and the fourth groove 18 only are constructed to isolate the first antenna 12 from the third antenna 14 and the second antenna 13 from the third antennas 14, respectively. Similarly in FIG. 2, the four antennas and six grooves are constructed on the substrate 21 based on the above teaching the embodiment of FIG. 1. Further, the construction of the grooves and the antennas in the following embodiments of FIG. 4 to FIG. 7C does also follow the same guideline established above.

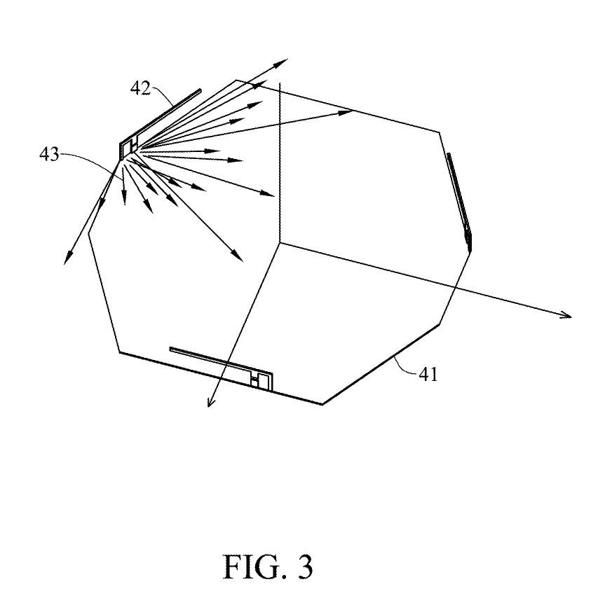

Referring now to FIG. 3, a distribution of radiation currents for the substrate without the grooves in accordance with the present invention is schematically shown. In this figure, three antennas are located over the substrate 41. To simplify the explanation, the antenna 42 at the upper left portion of the substrate 41 is taken as a typical example for elucidation. After the substrate 41 is powered on by a foreign source, and while the antennas 42 is transmitting/receiving radiation signals, radiation current lines 43 over the substrate 41 would be generated to radiate by having the antenna as the radiation center. Since no additional object in the figure is present to possibly affect the radiation, the radiation current lines 43 in the figure shall be extended outward linearly. Without hesitation, the radiation current lines 42 would inevitably intersect with the other radiation current lines for the other two antennas, and thus signal interference between the antennas occurs so as thereby to cause ill signal transmission to the involved antennas.

Referring now to FIG. 4, a distribution of radiation currents for the substrate with the grooves in accordance with the present invention is schematically shown. In this example, since two grooves 44 are constructed to isolate the antenna 42 so as to substantially prevent the radiation current lines 43 of the antenna 42 from affecting the other two antennas, the quality of signal transmission of the isolated antenna 42 can be ensured, and also the antenna can thus be operated with more bandwidth selections.

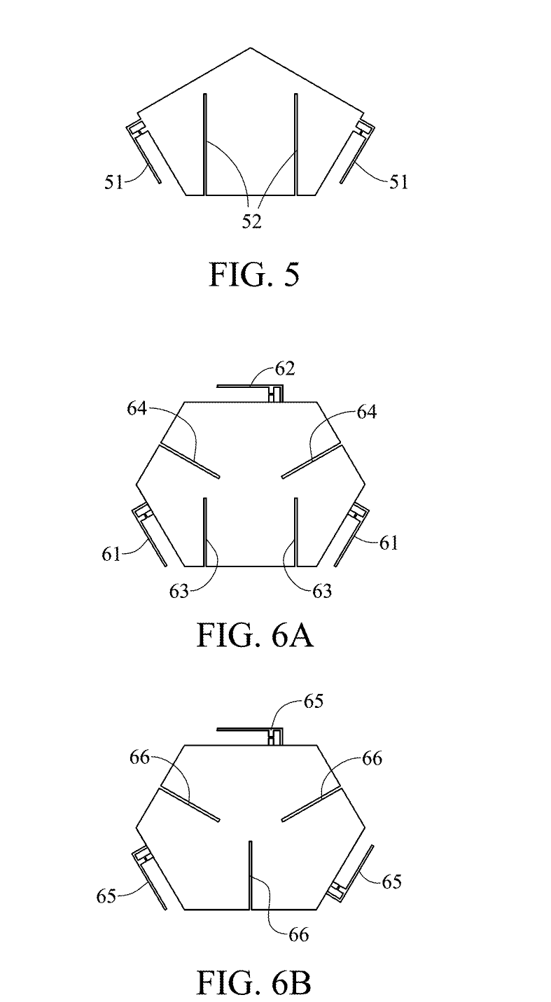

In the following illustrations of FIG. 5 through FIG. 7C, the drawings of antennas which are shown aside to the respective polygons of the substrates are only for a clear-description purpose, not for practical embodiments. Actually, in each embodiment of this disclosure, the position relationship between the antenna and the substrate is exactly shown in each of FIG. 1 through FIG. 4.

Referring now to FIG. 5, the substrate shaped as a symmetric pentagon is schematically shown. In this embodiment, the two antennas 51 are crossed in a manner of virtual extension lines from the free radiation ends of the antennas 51. Hence, at least two grooves 52 (two in this figure) shall be constructed between the two antennas 51 so as to avoid interference of the respective radiation current lines.

Referring now to FIG. 6A, a first embodiment of the substrate shaped as a symmetric hexagon is schematically shown. In this embodiment, the two antennas 61 are crossed in a manner of virtual extension lines from the free radiation ends of the antennas 61. Hence, at least two grooves 63 (two in this figure) shall be constructed between the two antennas 61 so as to avoid interference of the respective radiation current lines. On the other hand, the antenna 62 is not crossed with any of the antennas 61 in a manner of virtual extension lines from the free radiation ends of the corresponding antennas. Thus, only one groove 64 is required between the antenna 52 and any of the antennas 61.

Referring now to FIG. 6B, a second embodiment of the substrate shaped as a symmetric hexagon is schematically shown. All the three antennas 65 are not crossed with each other in a manner of virtual extension lines from the free radiation ends of the corresponding antennas. Thus, only one groove 66 is required between any two of the antennas 65.

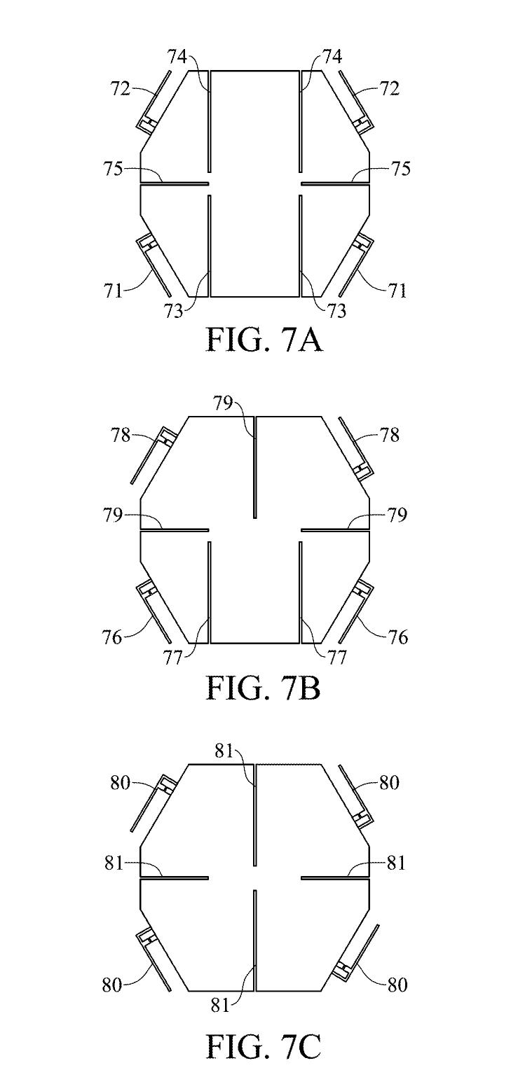

Referring now to FIG. 7A, a first embodiment of the substrate shaped as a symmetric octagon is schematically shown. In this embodiment, the two antennas 71 are crossed in a manner of virtual extension lines from the free radiation ends of the antennas 71. Hence, at least two grooves 73 (two in this figure) shall be constructed between the two antennas 71 so as to avoid interference of the respective radiation current lines. Similarly, the two antennas 72 are crossed in a manner of virtual extension lines from the free radiation ends of the antennas 72. Hence, at least two grooves 74 (two in this figure) shall be constructed between the two antennas 72 so as to avoid interference of the respective radiation current lines. On the other hand, the two neighboring antennas 71, 72 are not crossed with each other in a manner of virtual extension lines from the free radiation ends of the corresponding antennas. Thus, only one groove 75 is required between the antenna 72 and the antenna 71.

Referring now to FIG. 7B, a second embodiment of the substrate shaped as a symmetric octagon is schematically shown. In this embodiment, the two antennas 76 are crossed in a manner of virtual extension lines from the free radiation ends of the antennas 76. Hence, at least two grooves 77 (two in this figure) shall be constructed between the two antennas 76 so as to avoid interference of the respective radiation current lines. On the other hand, the two neighboring antennas 76, 78 are not crossed with each other in a manner of virtual extension lines from the free radiation ends of the corresponding antennas. Thus, only one groove 79 is required between the antenna 76 and the antenna 78. Similarly, the two neighboring antennas 78 are also not crossed with each other in a manner of virtual extension lines from the free radiation ends of the corresponding antennas. Thus, only one groove 79 is required between the two antennas 78.

Referring now to FIG. 7C, a third embodiment of the substrate shaped as a symmetric octagon is schematically shown. In this embodiment, none of the antennas 80 is crossed with the neighboring antenna 80 in a manner of virtual extension lines from the free radiation ends of the corresponding antennas. Thus, only one groove 81 is required between any two antennas 80.

According to the embodiments of FIG. 1 through FIG. 7C, it is clear that the multi-antenna structure with high-isolation effect provided herein can improve and relevantly adjust the isolation of an MIMO (Multi-input multi-output) antenna of a wireless communication device, according to specific requirements. The embodiments raised above in this disclosure are applicable to operational frequency bandwidths at 802.11a (5150˜5850 MHz), 802.11b (2400˜2500 MHz), and 802.11g (2400˜2500 MHz). In addition, according to the present invention, the bandwidth can be slightly adjusted, particularly wider, to meet other requirements of antennas for wireless communication apparatuses. By having the multi-antenna structure with high-isolation effect of the present invention to be applied to the multi-antenna and multi-bandwidth electronic product, the merchandise value can be significantly increased, and thus the subject matter of the present invention is worthy to be patent-protected.

While the present invention has been particularly shown and described with reference to a preferred embodiment, it will be understood by those skilled in the art that various changes in form and detail may be without departing from the spirit and scope of the present invention.

What is claimed is:

1. A multi-antenna structure with high-isolation effect, comprising:
a substrate, formed as a symmetric polygonal metal board having at least five sides, having a plurality of grooves and a plurality of board edges; and
a plurality of antennas, each of the antennas being constructed vertically to the respective board side, each of the board edges being allowed only to mount at most one said antenna, a conjunction portion of one said antenna and the substrate including a support member and a feed-in member, a radiation member of the antenna being extended from the conjunction portion and also perpendicular to the support member and the feed-in member, an free extension end of the radiation member being defined as a radiation end;
wherein, in the case that any two said neighboring antennas are crossed in a manner of virtual extension lines extended from the corresponding free radiation ends, at least two grooves are constructed on the substrate by being disposed between the two said neighboring antennas;
wherein, in the case that any two said neighboring antennas are not crossed in a manner of virtual extension lines from the corresponding free radiation ends, at least one groove is constructed on the substrate to separate the two neighboring antennas so as thereby to avoid possible signal interference between these two antennas.

2. The multi-antenna structure with high-isolation effect of claim 1, wherein the groove is extended by perpendicular to the respective board edge of the substrate.

3. The multi-antenna structure with high-isolation effect of claim 1, wherein the symmetric polygonal metal board is shaped as one of a pentagon, a hexagon and an octagon.

4. The multi-antenna structure with high-isolation effect of claim 3, wherein the pentagon has two said antennas located symmetrically.

5. The multi-antenna structure with high-isolation effect of claim 3, wherein the hexagon has three said antennas located symmetrically.

6. The multi-antenna structure with high-isolation effect of claim 3, wherein the octagon has four said antennas located symmetrically.

7. The multi-antenna structure with high-isolation effect of claim 1, wherein the feed-in member further has a middle cutoff portion for electrically coupling a coaxial cable, a conductive core and a woven conductive shield of the coaxial cable being electrically connected to opposing ends of the cutoff portion, respectively.

8. The multi-antenna structure with high-isolation effect of claim 1, wherein a length of the groove is to vary impedance matching the antennas.

9. The multi-antenna structure with high-isolation effect of claim 1, wherein the groove is extended inward from the respective board side of the substrate.

10. The multi-antenna structure with high-isolation effect of claim 1, wherein the substrate and the plurality of antennas are integrated as a single piece.

11. A multi-antenna structure with high-isolation effect, comprising:
a substrate, formed as a symmetric polygonal metal board having at least five sides, having a plurality of grooves and a plurality of board edges; and
a plurality of antennas, each of the antennas being constructed vertically to the respective board side, each of the board edges being allowed only to mount at most one said antenna, a conjunction portion of one said antenna and the substrate including a support member and a feed-in member, a radiation member of the antenna being extended from the conjunction portion and also perpendicular to the support member and the feed-in member, an free extension end of the radiation member being defined as a radiation end, the feed-in member being electrically coupled with a coaxial cable;
wherein, in the case that any two said neighboring antennas are crossed in a manner of virtual extension lines extended from the corresponding free radiation ends, at least two grooves are constructed on the substrate by being disposed between the two said neighboring antennas;
wherein, in the case that any two said neighboring antennas are not crossed in a manner of virtual extension lines from the corresponding free radiation ends, at least one groove is constructed on the substrate to separate the two neighboring antennas so as thereby to avoid possible signal interference between these two antennas.

12. The multi-antenna structure with high-isolation effect of claim 11, wherein a length of the groove is to vary impedance matching the antennas.

13. The multi-antenna structure with high-isolation effect of claim 11, wherein the substrate and the plurality of antennas are integrated as a single piece.
